(19) United States
(12) Patent Application Publication
(10) Pub. No.: US 2008/0179346 A1
(43) Pub. Date: Jul. 31, 2008

(54) Method and assembly for dispensing semi-frozen beverages

(76) Inventor: Kevin Downey, Warren, PA (US)

Correspondence Address: THE BILICKI LAW FIRM, PC, 1285 North Main Street, JAMESTOWN, NY, 14701, US

(21) Appl. No.: 11/698,347

(22) Filed: Jan. 26, 2007

(51) Int. Cl. B67D 5/62

(52) U.S. Cl. 222/146.6; 62/342; 222/129.1

(57) ABSTRACT

An assembly for maintaining an adequate volume and optimal temperature of semi-frozen beverages contained within a plurality of dispensing units. The assembly includes a chilled water source for providing water cooled to a temperature just above freezing, a plurality of valves and a plurality of water conduits, a plurality of additive sources and additive conduits, and a plurality of beverage conduits. Each beverage conduit is in fluid communication with one valve of the plurality of valves and a vessel of one of the at least one beverage dispensing modules, each of the valves is adapted to mix said chilled water and additive in a desired ratio and deliver an additive-chilled water mixture to said vessel of one of said at least one beverage dispensing modules.

### BRIEF DESCRIPTION OF THE DRAWINGS

FIG. 1 is a side view of a beverage dispensing unit in accordance with one embodiment of the invention.

FIG. 2 is a perspective view of an assembly for maintaining an adequate volume and optimal temperature of semi-frozen beverages contained within a plurality of dispensing units in accordance with one embodiment of the invention.

FIG. 3 is a perspective view of a water cooling device in accordance with one embodiment of the invention.

FIG. 4 is a perspective view of a portion of the assembly for maintaining an adequate volume and optimal temperature of semi-frozen beverages contained within a plurality of dispensing units in accordance with one embodiment of the invention.

FIG. 5 is an alternate embodiment of the housing.

FIG. 6 is an enlarged view of a portion of FIG. 5.

FIG. 7 is an alternate view of the assembly for maintaining an adequate volume and optimal temperature of semi-frozen beverages.

### DETAILED DESCRIPTION OF EMBODIMENTS OF THE INVENTION

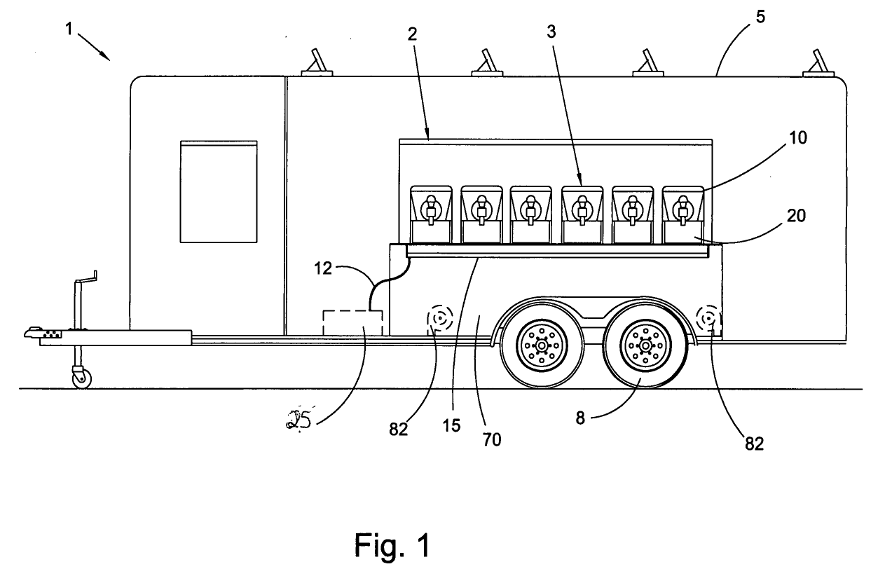

As shown generally in FIG. 1, a beverage dispensing assembly 1 containing a sub-assembly 2 for maintaining an adequate volume and optimal temperature of semi-frozen beverages contained within a plurality of dispensing units, each of which is indicated at 3, is provided. In one embodiment, beverage dispensing assembly 1 includes a housing 5 having wheels 8. However, housing 5 may be a trailer adapted to be attached to a vehicle and transported to various locations. Alternatively, housing 5 may be a fixed structure positioned in a permanent location. As will be discussed in detail below, each dispensing unit 3 is shown to include one or more beverage modules 10. In the embodiment shown, each dispensing unit 3 includes two beverage modules 10. However, it should be recognized that the number of dispensing units 3 and modules 10 per dispensing unit is not meant to be limiting. Disposed beneath the plurality of dispensing units 3 is a drip tray 15 which may be a unified drip tray that spans the entire with of the plurality of dispensing units 3. Drip tray 15 may be constructed of sheet metal or any other appropriate material. As the semi-frozen beverage is dispensed from beverage modules 10, any drips or spills are caught by drip tray 15. The drain line 12 leads from the drip tray 15 to the liquid holding tank 25 or other receptacle. Assembly 1 may have a control box (discussed in greater detail infra).

As discussed above, each dispensing unit 3 includes one or more beverage modules 10. Each dispensing unit 3 also includes a refrigeration component 20. The refrigeration component 20, is well known in the art, generally includes auger motors, auger capacitators, auger shafts, auger control switches, circuit breaker, a compressor or compressors, contactor, cooling drum, cooling drum support, day/night switch, dispenser switch, electrical controls, fan, fuse and fuse holder, temperature sensor, ice/off/no-ice switches, lamp cord, lamp holder/socket assembly, LCD display board, solenoids, torque sensor circuit board, and transformer.

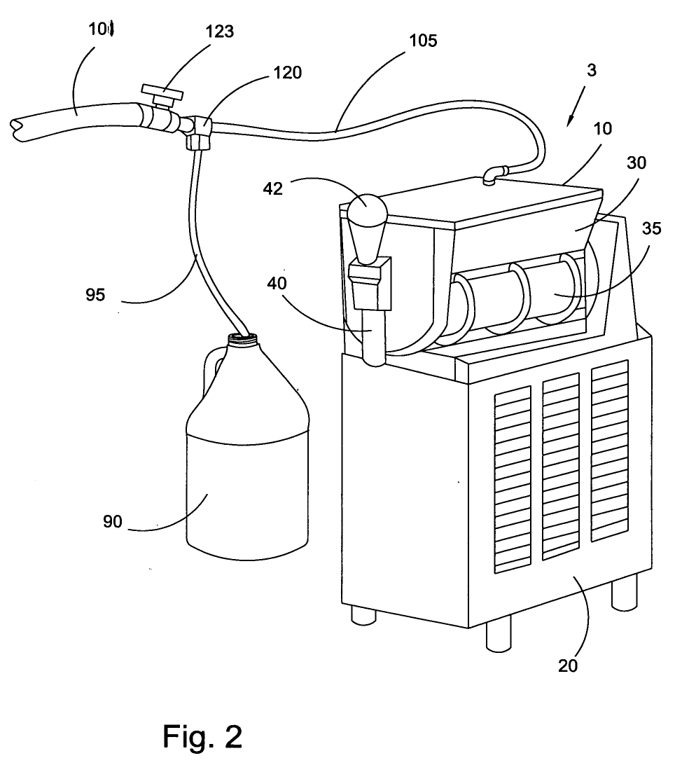

Refrigeration component 20 supports beverage modules 10, as shown in FIG. 2. Each beverage dispensing module 10 further includes a vessel 30 for containing frozen beverage, a mixing blade 35 and dispensing valve 40. A blend of additives, which will be discussed in detail below, enters each beverage dispensing module 10 at a rear or top portion thereof. The refrigeration component 20 is connected to each dispensing module 10 and maintains the beverage at a consistent temperature so that there is a constant supply of semi-frozen beverage. Mixing blade 35 is substantially housed within vessel 30 and is adapted to either be in motion or stationary. The contents of vessel 30 are dispensed via dispensing valve 40. The dispensing may be accomplished by any number of ways, for example as shown in FIG. 2, by a pull lever 42. Other mechanisms may include a push button, a sensor, a push-in lever, a twist spout, or any other known form in the art. The pull level as show is not meant to be limiting.

As further shown in FIG. 1, each dispensing unit 3 may be aligned adjacent to one another without side panels therebetween. The lack of side panels increases the cooling efficiency of assembly 1. However, in alternate embodiments, dispensing units 3 may include separating side panels (not shown). FIG. 1 also illustrates an exhaust chamber 70 positioned adjacent to each refrigeration component 20 of said plurality of dispensing units 3. In this embodiment two heat evacuators 82, such as fans, are shown. However, it should be recognized that the number of heat evacuators 82 is not meant to be limiting. Also, while two exhaust fans are shown in FIG. 1, any number or type of heat evacuators 82 may be present, such as fans, blowers, heat sinks, etc.

Heat evacuators 82 are substantially housed within exhaust chamber 70. The heat given off by plurality of dispensing units 3 and other components of assembly 1 or any other source that would increase the heat within assembly 1 or the housing it is contained in, is drawn away via heat evacuators 82. The heat is evacuated outside exhaust chamber 70 and outside housing 5 and directed at any angle that would divert the heat substantially away from dispensing assemblies 3 and does not encourage the heat to be recaptured by assembly 1 or housing 5. Heat evacuators 82 alternatively may be plumbed and exhausted remotely from dispensing units 3, may be ducted and evacuated, or rigged by any other means known in the art such that the heat is evacuated from the interior space of housing 5 to encourage maintenance of a constant temperature.

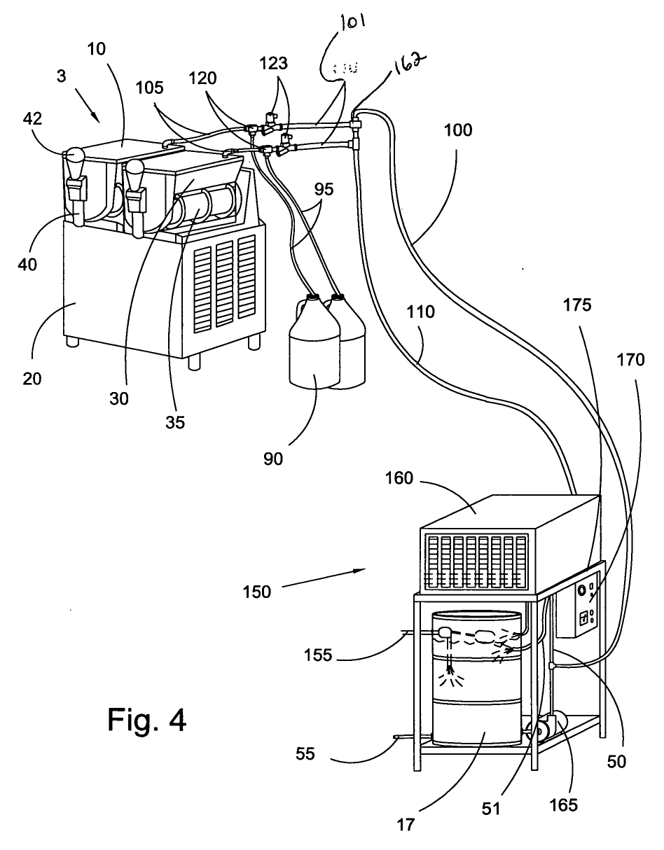

FIG. 2 depicts a view of an additive source 90 in connection with an additive conduit 95, and a water conduit 100, all being fluidly connected to a beverage conduit 105 by a valve 120, which may be an injector valve or an injector valve with a venture fitting inside or any other valves known in the art. Beverage conduit 105 is fluidly connected to beverage dispensing module 10. FIG. 4 shows, generally, two beverages dispensing modules 10 being fluidly connected to separate beverage conduits 105, however this is not meant to be limiting.

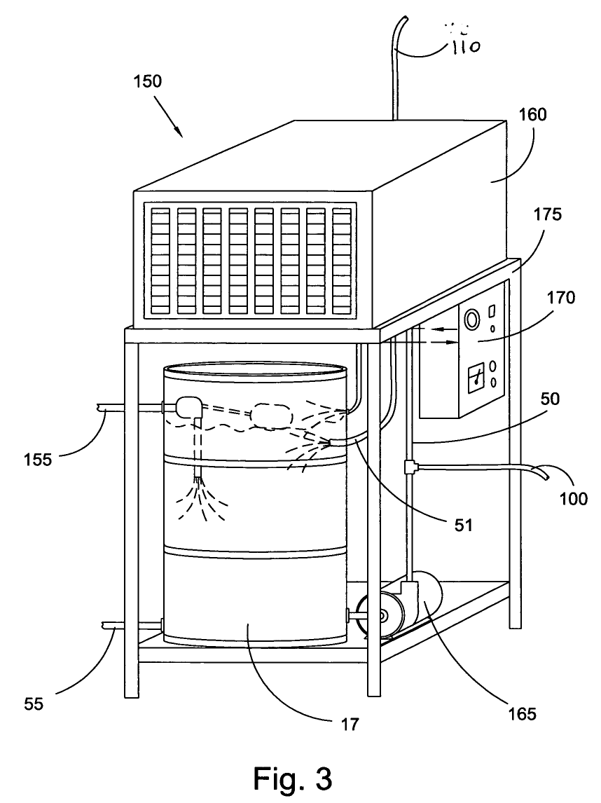

FIG. 3 generally illustrates a view of a cooling unit 150. The cooling unit 150 is comprised of a potable water source 155, a water chiller 160, a water pump 165, a control panel 170, a liquid holding tank 17 and a support structure 175. Water source 155 further is fluidly connected to liquid holding tank 17. Liquid holding tank 17 is fluidly connected to a first water chilling conduit 50 and a second water chilling conduit 51. Water conduit 100 is fluidly connected either to first water chilling conduit 50 or second water chilling conduit 51. Control panel 170 includes a remote thermostat, an on/off switch, pressure gage, and volume indicator (not separately labeled). The thermostat may have manual adjustment of the temperature and an automatic detect and correct mechanism to maintain the selected temperature. The volume indicator on control panel 170 may be used to calculate inventory; volume consumed may be calculated into volume of slush sold, which may serve as a check against cash flow and receipts. Although in this instance one cooling unit 150 is depicted, the number of cooling units 150 is not meant to be limiting.

FIG. 3 generally depicts the flow of water and the means by which the water is cooled. Water is drawn through first water cooling conduit 50 by a pump 165 into cooling compartment 160. Water is returned through second water cooling conduit 51 to liquid holding tank 17. This mechanism maintains the temperature of the water in liquid holding tank 17. Although one pump 165 and one water cooling conduit 50 are shown in this embodiment, there may be a plurality of pumps and/or a plurality of water cooling conduits, as this embodiment is not meant to be limiting.

As shown generally in FIG. 4, an unhoused assembly 1 for maintaining an adequate volume and optimal temperature of semi-frozen beverages contained within plurality of dispensing units 3, is provided. Cooling unit 150 has potable water source 155 feeding into liquid holding tank 17. Liquid holding tank 17 is fluidly connected to a first water chilling conduit 50. First water chilling conduit 50 is fluidly connected to water conduit 100, which is split via a plurality of joints 162 into a plurality of secondary water conduits 101. Each secondary water conduit 101 may be fluidly connected with an additive source 90 via an additive conduit 95, and fluidly connected via a valve 120 to a beverage conduit 105. Each beverage conduit 105 is fluidly connected to a respective beverage dispensing module 10. A return water conduit 110 routes back to liquid holding tank 17 after passing all joints 162. This circulation loop allows for a chilled water supply to always be available for immediate use. The singular or plural nature of the features depicted in this embodiment is not meant to be limiting.

As shown in FIGS. 4, 6 and 7, assembly 1 also includes a plurality of electric valves 123. Each electric valve 123 is positioned on a respective secondary water conduit 101 and is electrically coupled to a control panel 125 such that valves 123 can be opened or closed remotely. When an actuator (not labeled), which corresponds to one of electric valves 123 is engaged, electric valve 123 opens to allow water to flow through the respective secondary water conduit 101. When water flows through secondary water conduits 101, corresponding beverage modules 10 are subsequently filled with beverage. The amount of beverages that will be released into beverage modules 10 may be preset and may be in any quantity that would not disturb the flow of the beverage being dispensed via dispensing valve 40. For example, 8 ounces, 16 ounces, 32 ounces, or any other quantity known in the art may be added by activating the desired actuator on control panel 125. Also, the flow and length of injection time of the beverages may be adjusted to suit the user's needs. For example, the beverages may be added gradually over many minutes, or quickly in less than one minute. Thus, assembly 1 may be operated by only one person, wherein this person can monitor the level of beverages in beverage modules 10 and engage in selling the beverages.

As discussed above, the water in liquid holding tank 17 is cooled to almost freezing by water chiller 160. The almost freezing water flows from liquid holding tank 17 through first water conduit 50 and through water conduit 100 that is fluidly connected via joint 162 and valves 123 and 120 to a beverage conduit 105. Although the temperature of the water flowing through water conduit 100 is referred to as almost freezing, the temperature is not meant to be limiting. However, maintaining a temperature of between 32 and 40 degrees Fahrenheit efficiently maintains the semi-frozen state of the beverages within vessels 30. Electric valve 123 works in conjunction with valve 120 to regulate the addition of a water-additive mixture. Valve 120 further fluidly connects additive conduit 95 and a water-additive mixture flows through beverage conduit 105 to beverage dispensing module 10 of beverage dispensing unit 3. Beverage dispensing unit 3 continues to cool and partially freeze the water-additive mixture, resulting in a semi-frozen beverage. Mixing blade 35, mixes the semi-frozen beverage and dispensing tap 40 releases the beverage into a desired container.

Referring again to FIG. 4, water conduit 100 may be split at a plurality of joints 162, and a plurality of secondary water conduits 101 may be fluidly connected to respective additive sources 90 via respective additive conduits 95 and valves 120. Each of the respective water-additive mixtures flows through separate beverage conduits 105 to individual beverage dispensing modules 10.

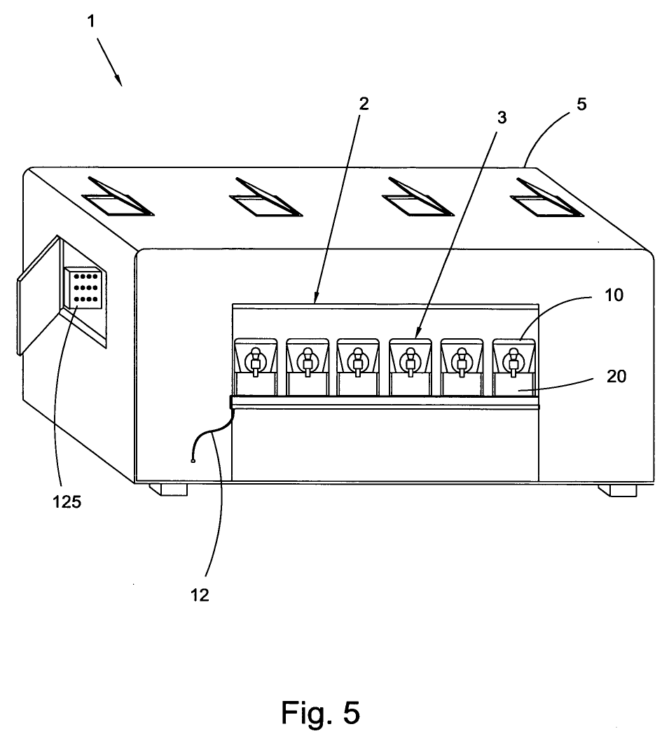

As shown generally in FIG. 5, assembly 1 may be non-mobile. Assembly 1 may be located in a fixed position within a larger store structure, within a non-mobile housing 5, or within a portable housing 5. The structure of housing 5 is not meant to be limiting.

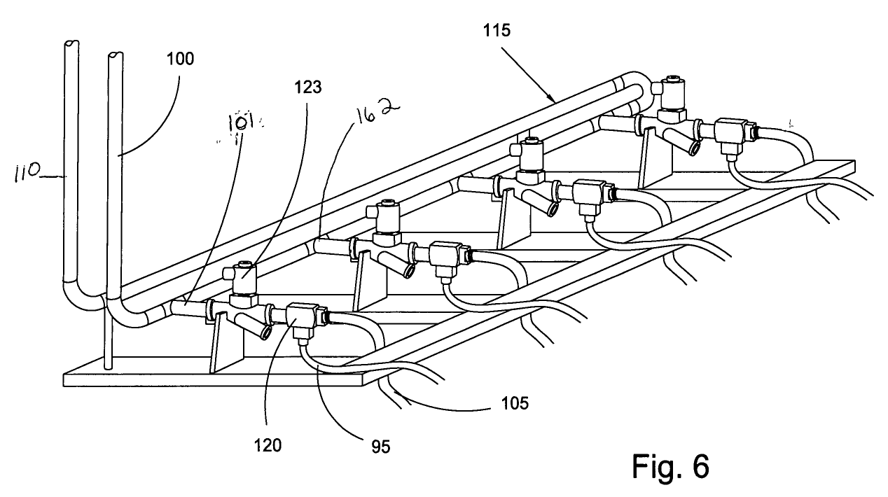

As shown generally in FIG. 6 and as discussed above, water conduit 100 may be split into a plurality of secondary water conduits 101 by a plurality of joints 162. Electric valves 123 may be connected to each secondary water conduit 101 for controlling the flow of water therethrough. Each electric valve 123, which is connected to control panel 125, is coupled with respective valve 120. Electrical valve 123 controls when, how much, the flow of, and how long a mixed feed solution is added through beverage conduit 105 to the beverage module 10 (not shown). Valve 120 is fluidly connected to an additive conduit 95 and fluidly connected to a beverage conduit 105.

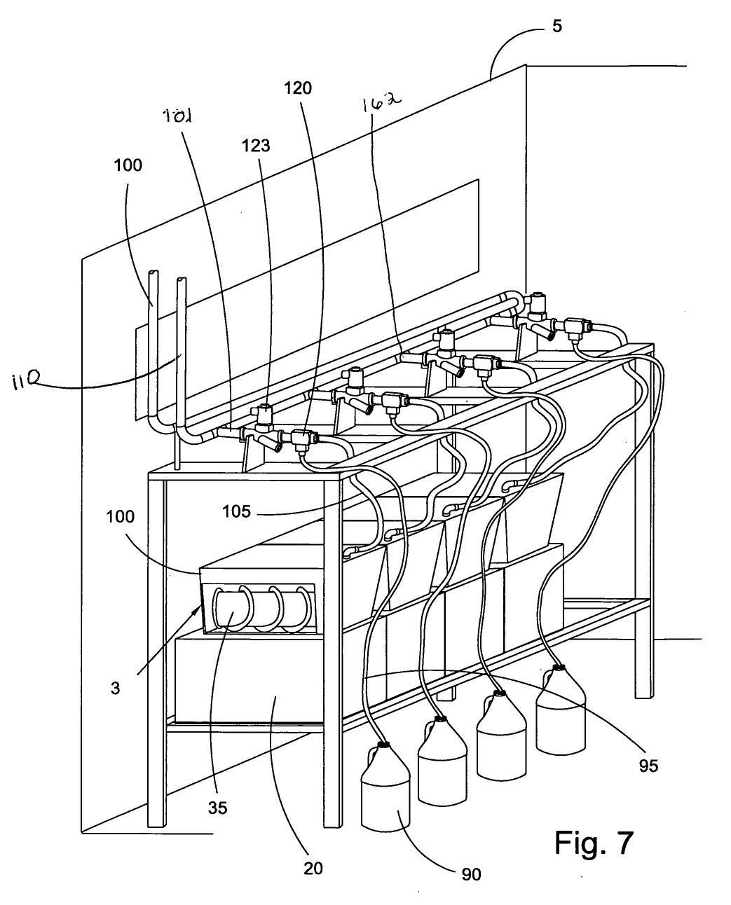

As shown generally in FIG. 7, the inside of housing 5 may have water conduit 100 split by joints 162. A constant flow of chilled water flows through water conduit 100, secondary conduits 101, and return conduit 110 back to liquid holding tank 17. The orientation of this assembly and the number of units present are demonstrative and not meant to be limiting, as one in ordinary skill in the art would appreciate alternative arrangements, both in orientation and number of units.

Although described with reference to embodiments of the invention, it should be readily understood that various changes and/or modifications can be made to the invention without departing from the spirit thereof. For example, the number of dispensing units and/or modules may vary. In general, the invention is only intended to be limited by the scope of the following claims.

We claim:

1. An assembly for maintaining a preset volume and temperature of beverages contained within a plurality of dispensing units, each dispensing unit having a refrigeration component and at least one beverage dispensing module with a vessel for containing a beverage in a semi-frozen state, a mixing blade for mixing said semi-frozen beverage, and a dispensing valve for dispensing said semi-frozen beverage, said assembly comprising:
a chilled water source for providing water cooled to a preset chilled temperature;
a plurality of valves;
a plurality of water conduits, each water conduit of said plurality of water conduits in fluid communication with said water source and one valve of said plurality of valves for facilitating the transfer of water from said water source to said plurality of valves;
a plurality of additive sources;
a plurality of additive conduits, each one of said plurality of additive conduits being fluidly connected to one additive source of said plurality of additive sources and one valve of said plurality of valves for facilitating the transfer of additive from said additive source to said valve;
a plurality of beverage conduits, each beverage conduit being in fluid communication with one valve of said plurality of valves and the vessel of one of said at least one beverage dispensing modules, each of said valves being adapted to mix said chilled water and additive in a desired ratio and deliver an additive-chilled water mixture to said vessel of one of said at least one beverage dispensing modules;
an exhaust chamber positioned adjacent to each refrigeration component of said plurality of dispensing units, said exhaust chamber having at least one exhaust fan for transporting heated air from said refrigeration component of each dispensing unit away from said dispensing units.

2. The assembly for maintaining a preset volume and temperature of semi-frozen beverages contained within a plurality of dispensing units according to claim 1, wherein said refrigeration components of said plurality of dispensing units do not contain side panels.

3. The assembly for maintaining a preset volume and temperature of semi-frozen beverages contained within a plurality of dispensing units according to claim 1, wherein said exhaust chamber is formed from sheet metal.

4. The assembly for maintaining a preset volume and temperature of semi-frozen beverages contained within a plurality of dispensing units according to claim 1 further comprising a plurality of electrical valves and a control panel, each electrical valve of said plurality of electrical valves in fluid communication with one water conduit of said plurality of water conduits, wherein said plurality of electrical valves is electrically connected to the control panel for controlling the flow of water through said plurality of water conduits.

5. The assembly for maintaining a preset volume and temperature of semi-frozen beverages contained within a plurality of dispensing units according to claim 1, wherein said chilled water source is a water refrigeration component.

6. The assembly for maintaining a preset volume and temperature of semi-frozen beverages contained within a plurality of dispensing units according to claim 1, further comprising a drip tray positioned below said dispensing valves of said plurality of dispensing units.

7. The assembly for maintaining a preset volume and temperature of semi-frozen beverages contained within a plurality of dispensing units according to claim 1, further comprising a housing for containing said assembly and plurality of dispensing units, said housing including an opening through which a user can access and view said dispensing valves, beverage modules and drip tray.

8. The assembly for maintaining a preset volume and temperature of semi-frozen beverages contained within a plurality of dispensing units according to claim 7, wherein said housing is a mobile unit.

9. A beverage dispensing assembly comprising:
a plurality of dispensing units, each dispensing unit having a refrigeration component and at least one beverage dispensing module with a vessel for containing a beverage in a semi-frozen state, a mixing blade for mixing said semi-frozen beverage, and a dispensing valve for dispensing said semi-frozen beverage;
a chilled water source for providing water cooled to a preset chilled temperature;
a plurality of valves;
a plurality of water conduits, each water conduit of said plurality of water conduits in fluid communication with said water source and one valve of said plurality of valves for facilitating the transfer of water from said water source to said plurality of valves;
a plurality of additive sources;
a plurality of additive conduits, each one of said plurality of additive conduits being fluidly connected to one additive source of said plurality of additive sources and one valve of said plurality of valves for facilitating the transfer of additive from said additive source to said valve;
a plurality of beverage conduits, each beverage conduit being in fluid communication with one valve of said plurality of valves and a vessel of one of said at least one beverage dispensing modules, each of said valves being adapted to mix said chilled water and additive in a desired ratio and deliver an additive-chilled water mixture to said vessel of one of said at least one beverage dispensing modules;
an exhaust chamber positioned adjacent to each refrigeration component of said plurality of dispensing units, said exhaust chamber having at least one exhaust fan for transporting heated air from said refrigeration components away from said plurality of dispensing units;
a drip tray positioned below said dispensing valves of said plurality of dispensing units; and
a housing for containing said assembly and plurality of dispensing units, said housing including an opening through which a user can access and view said dispensing valves, beverage modules and drip tray.

10. The beverage dispensing unit of claim 9 wherein said housing includes wheels such that said beverage dispensing unit is mobile.

11. The beverage dispensing unit according to claim 1 further comprising a plurality of electrical valves and a control panel, each electrical valve of said plurality of electrical valves being in fluid communication with one water conduit of said plurality of water conduits, wherein said plurality of electrical valves is electrically connected to the control panel for controlling the flow of water through said plurality of water conduits.

12. A method of providing a plurality of semi-frozen beverages to be dispensed from a plurality of dispensing units, each dispensing unit having a refrigeration component and at least one beverage dispensing module with a vessel for containing a beverage in a semi-frozen state, a mixing blade for mixing said semi-frozen beverage, and a dispensing valve for dispensing said semi-frozen beverages, said method comprising the steps of:
cooling water from a water source to a preset chilled temperature;
transferring cooled water to a plurality of valves through a plurality of water conduits;
transferring additives from a plurality of additive sources to said plurality of valves through a plurality of additive conduits;
mixing said plurality of additives with said cooled water to form a plurality of cooled water-additive mixtures;
transferring each of said plurality of cooled water-additive mixtures to a vessel of one of said plurality of beverage dispensing units; and
exhausting heat generated by said plurality of beverage dispensing units by directing heated air through an exhaust chamber located below said plurality of beverage dispensing units by an exhaust fan.

13. The method according to claim 12, wherein said refrigeration components of said plurality of dispensing units do not contain side panels.

14. The method according to claim 12, wherein said exhaust chamber is formed from sheet metal.

15. The method according to claim 12, wherein said step of transferring cooled water to a plurality of valves through a plurality of water conduits is controlled by a plurality of electric valves and a control panel being electrically coupled to said plurality of electric valves.

16. The method according to claim 12, further comprising a drip tray positioned below said dispensing valves of said plurality of dispensing units.

17. The method according to claim 12, further comprising a housing for containing said assembly and plurality of dispensing units, said housing including an opening through which a user can access and view said dispensing valves, beverage modules and drip tray.

18. The method according to claim 17, wherein said housing is a mobile unit.

19. An assembly for maintaining a preset volume and temperature of a beverage contained within at least one dispensing unit, said dispensing unit having a refrigeration component and at least one beverage dispensing module with a vessel for containing a beverage in a semi-frozen state, a mixing blade for mixing said semi-frozen beverage, and a dispensing valve for dispensing said semi-frozen beverage, said assembly comprising:
a chilled water source for providing water cooled to a preset chilled temperature;
a valve;
a water conduit, said water conduits in fluid communication with said water source and valve for facilitating the transfer of water from said water source to valve;
an additive source;
an additive conduit, said additive conduit being fluidly connected to said additive source and said valve for facilitating the transfer of additive from said additive source to said valve;
a beverage conduit in fluid communication with said valve and the vessel of one of said at least one beverage dispensing modules, said valve being adapted to mix said chilled water and additive in a preset ratio and deliver an additive-chilled water mixture to said vessel of one of said at least one beverage dispensing modules;
an exhaust chamber positioned adjacent to the refrigeration component of the dispensing unit, said exhaust chamber having at least one exhaust fan for transporting heated air from said refrigeration component away from said dispensing unit.

20. The assembly for maintaining a preset volume and temperature of semi-frozen beverages contained within at least one dispensing unit according to claim 19, wherein said exhaust chamber is formed from sheet metal.

21. The assembly for maintaining a preset volume and temperature of semi-frozen beverages contained within at least one dispensing unit according to claim 19 further comprising an electrical valves and a control panel, said electrical valve in fluid communication with said water conduit, wherein said electrical valve is electrically connected to the control panel for controlling the flow of water through said water conduit.

22. The assembly for maintaining a preset volume and temperature of semi-frozen beverages contained within at least one dispensing unit according to claim 19, wherein said chilled water source is a water refrigeration component.

23. An assembly for facilitating the dispensing of semi-frozen beverages contained within at least one dispensing unit, said assembly comprising:
a chilled water source for providing water cooled to a preset chilled temperature;
a valve;
a water conduit, said water conduits in fluid communication with said water source and valve for facilitating the transfer of water from said water source to valve;
an additive source;
an additive conduit, said additive conduit being fluidly connected to said additive source and said valve for facilitating the transfer of additive from said additive source to said valve;
a beverage conduit in fluid communication with said valve and adapted to be connected to a vessel of a beverage dispensing module, said valve being adapted to mix said chilled water and additive in a preset ratio and deliver an additive-chilled water mixture to said vessel;
an exhaust chamber adapted to be positioned adjacent to a refrigeration component of a dispensing unit, said exhaust chamber having at least one exhaust fan adapted to transport heated air from said refrigeration component away from said dispensing unit.

24. An assembly for facilitating the dispensing of semi-frozen beverages contained within at least one dispensing unit according to claim 23 further comprising an electrical valves and a control panel, said electrical valve in fluid communication with said water conduit, wherein said electrical valve is electrically connected to the control panel for controlling the flow of water through said water conduit.
